(19) United States
(12) Patent Application Publication
(10) Pub. No.: US 2003/0111039 A1
(43) Pub. Date: Jun. 19, 2003

(54) Method and apparatus for laser welding hoses in an air induction system

(75) Inventors: Bobbye K. W. Baylis, Harrow (CA); Zhouxuan Xia, Windsor (CA)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive, Inc

(21) Appl. No.: 10/309,927

(22) Filed: Dec. 4, 2002

Related U.S. Application Data
(60) Provisional application No. 60/341,488, filed on Dec. 18, 2001.

(51) Int. Cl. F02M 35/02

(52) U.S. Cl. 123/198 E; 264/482

(57) ABSTRACT

Laser welding is used to attach a polyolefin air induction component to an elastomeric hose member. One of the hose or induction component includes a portion that is made from a transparent material. In one example, the hose includes a hose end portion that is formed from a transparent material. The transparent material is then positioned in an overlapping relationship to a tube received within an opening in the induction component, which acts as an absorbing component. Contour through transmission welding is used to generate a laser beam that passes through the transparent material, heats the absorbing component, which in turn heats the transparent material and forms a laser weld.

### CROSS-REFERENCE TO RELATED APPLICATIONS

The application claims priority to U.S. Provisional Application No. 60/341,488, which was filed on Dec. 18, 2001.

### BACKGROUND OF THE INVENTION

This invention relates to a method and system that uses laser welding for attachment of a hose to an air induction system component.

Typically, in an air induction system, hoses are attached to components such as air cleaners and resonators to provide a pathway for air moving through the air induction system. Traditionally, a tube member extends outwardly from the component and is attached to the hose with a metal clamp or an adhesive material.

These traditional attachment methods have several disadvantages. For example, additional materials are required such as a clamp member or an adhesive material that must be applied in an additional assembly step. These additional materials increase the overall weight and require time consuming assembly steps, which is undesirable.

Another disadvantage for a clamp attachment involves the interface between the tube and hose. The hose requires a wide flexible cuff and the mating tube member, over which the cuff is assembled, requires an increased wall thickness to accommodate material degradation that occurs under the clamp load. Another disadvantage with the adhesive material is that it is often messy and difficult to apply, resulting in an additional cleaning step during assembly.

One proposed solution is to use vibration welding to attach the hoses to the components. However, this technique requires relative motion between the hose and the tube to create friction, which heats up the materials to form the weld. Thus, apparatus is required to physically move at least one of the components, which can be undesirable if the components are large in size or complex in shape.

Thus, it is desirable to have a method and system that can attach a hose to an air induction system component that does not require the components or hoses to be moved and/or reduces the overall weight of the assembly, as well as overcoming the other above mentioned deficiencies with the prior art.

### SUMMARY OF THE INVENTION

A method for attaching a first induction component to a second induction component in an air induction system includes positioning the first and second induction components in an abutting relationship to define an overlap area and laser welding the overlap area to securely attach the components together.

Preferably, one of the components is made from a polyolefin material and the other of the components is made from an elastomeric material. Further, one of the materials is transparent to allow a laser beam to be directed through the transparent material of one component to the other component, which serves as an absorber. Thus, for example, if the elastomeric material is transparent then the transparent material is positioned in an overlapping relationship to the polyolefin component. A laser beam is generated that passes through the transparent material, heats the absorbing polyolefin component, which in turn heats the transparent material and forms the laser weld that attaches the components together. The components remain stationary while the laser beam travels with respect to the components.

In one disclosed embodiment, one of the induction components is a hose and the other induction component is a resonator or air cleaner. A tube extends outwardly from the resonator or air cleaner for mating engagement with the hose. The hose overlaps the tube or the tube overlaps the hose and the laser weld is applied at the overlap interface.

In an alternate embodiment, the tube includes a double wall configuration with an inner wall spaced apart from an outer wall to define a gap. The hose, which acts as the absorbing component, is the inserted into the gap and the laser weld is applied through the outer wall.

The subject system and method provide a simple and effective attachment method for attaching air induction components to each other. These and other features of the present invention can be best understood from the following specifications and drawings, the following of which is a brief description.

### BRIEF DESCRIPTION OF THE DRAWINGS

FIG. 1 is a schematic environmental view of an air induction system incorporating the subject invention.

FIG. 2 is a cross-sectional view of one embodiment of an air induction system incorporating the subject invention.

FIG. 3 is a cross-sectional view of an alternate embodiment of an air induction system incorporating the subject invention.

FIG. 4 is a cross-sectional view of an alternate embodiment of an air induction system incorporating the subject invention.

### DETAILED DESCRIPTION OF A PREFERRED EMBODIMENT

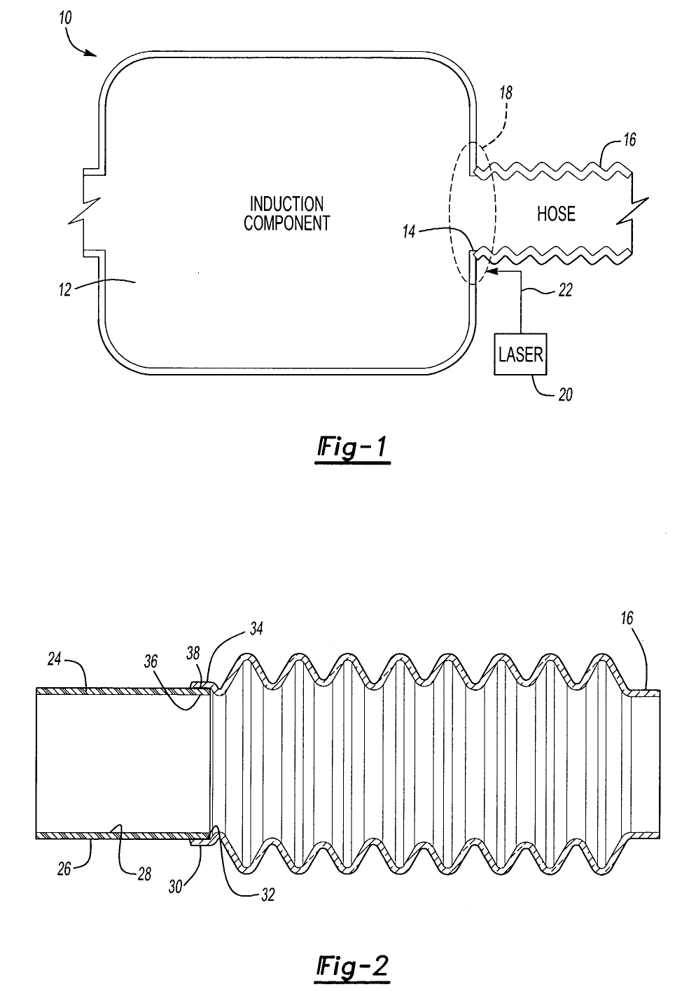

An air induction system is shown generally at 10 in FIG. 1. The air induction system 10 includes at least one air induction component 12 that defines an opening 14 for connection to a hose 16. The air induction component 12 can be any known induction component but is preferably a resonator or air cleaner the operation of which is well known in the art and will not be discussed in detail. Laser welding is directed at an attachment interface, indicated generally at 18, to attach the induction component 12 to the hose 16.

It should be understood that any type of laser welding process could be used to attach the hose 16 to the induction component 12. In the preferred embodiment, contour through transmission laser welding is used where a laser 20 generates a beam 22, which travels relative to the component 12 and hose 16. The beam 22 follows the contour of the attachment interface 18 to form the laser weld.

In the preferred embodiment, the induction component 12 is made from a polyolefin material and the hose 16 is made from an elastomeric material. Any type of polyolefin or elastomeric material known in the art could be used.

In one embodiment, shown in FIG. 2, the induction component 12 includes a tube 24 that is at least partially received within the opening 14. The tube 24 includes an outer surface 26 and an inner surface 28. The hose 16 also includes an outer surface 30 and an inner surface 32. In this embodiment, the tube 24 is received within the hose 16 such that a portion of the outer surface 26 of the tube 24 engages and overlaps a portion of the inner surface 32 of the hose 16.

To facilitate the laser welding process, the outer component (the hose 16 as shown in FIG. 2) is comprised of a transparent material and the inner component (the tube 24) serves as an absorbing component. An end 34 of the hose 16 is inserted over an end 36 of the tube 24 to define an overlap area. A laser welding area 38 is defined on this overlap area. The laser beam 22 is transmitted through the transparent material of the hose end 34 to heat the outer surface 26 of the tube 24, which in turn heats the inner surface 32 of the hose 16. As the laser 20 heats the components, the surfaces melt and a weld is formed.

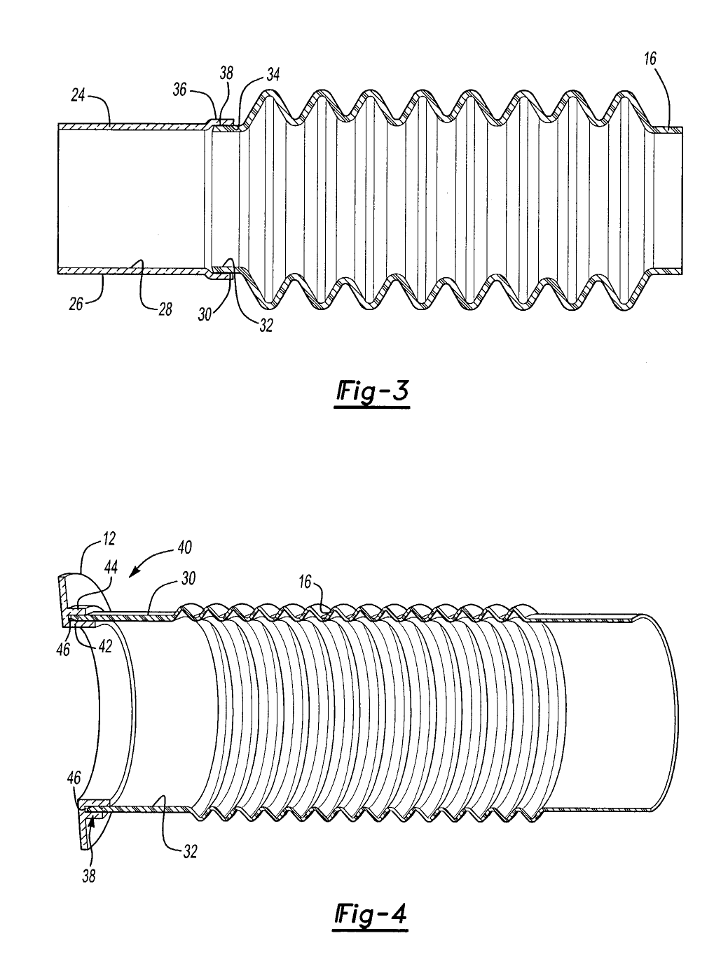

In an alternate embodiment, shown in FIG. 3, the hose 16 is received within the tube 24 such that a portion of the outer surface 30 of the hose 16 engages and overlaps a portion of the inner surface 28 of the tube 24. In this embodiment, the outer component (the tube 24) is comprised of a transparent material and the inner component (the hose 16) serves as an absorbing component. The end 36 of the tube 24 is inserted over the end 34 of the hose 16 to define the overlap area. The laser welding area 38 is defined on this overlap area. The laser beam 22 is transmitted through the transparent material of the tube end 36 to heat the outer surface 30 of the hose 16, which in turn heats the inner surface 28 of the tube 24. As the laser 20 heats the components, the surfaces melt and a weld is formed.

In an alternate embodiment, shown in FIG. 4, a double tube configuration, shown generally at 40, extends outwardly from the induction component 12. The double tube 40 includes an inner tube wall 42 spaced apart from an outer tube wall 44 to define a gap 46. The hose 16 is received within the gap 46 such that a portion of the outer surface 30 of the hose 16 engages the outer tube wall 44 and a portion of the inner surface 32 of the hose 16 engages the inner tube wall 42 to form an overlap between the tube 24 and hose 16. In this embodiment, the outer component (the tube 40) is comprised of a transparent material and the inner component (the hose 16) serves as an absorbing component. The laser welding area 38 is defined on the overlap area. The laser beam 22 is transmitted through the transparent material of the tube 40 to heat the the hose 16, which in turn heats the tube 40. As the laser 20 heats the components, the surfaces melt and a weld is formed.

The subject invention provides a method and system that attaches a hose 16 to an air induction system component 12, which does not require the components or hoses to be moved during attachment and includes the additional benefits of reducing the overall weight of the assembly and eliminating extra attachment hardware.

Although a preferred embodiment of this invention has been disclosed, a worker of ordinary skill in this art would recognize that certain modifications would come within the scope of this invention. For that reason, the following claims should be studied to determine the true scope and content of this invention.

1. An air induction system comprising:
a first component defining an opening;
a second component engaging said first component at an attachment interface and cooperating with said opening to direct air flow into or out of said first component; and
a laser weld area formed at said attachment interface for securely attaching said first and second components together.

2. An air induction system as set forth in claim 1 wherein said first component comprises a polyolefin material and said second component comprises an elastomeric material.

3. An air induction system as set forth in claim 1 wherein said attachment interface comprises an overlapping relationship between said first component and said second component.

4. An air induction system as set forth in claim 3 wherein said first component includes a first member overlapping a portion of one end of said second component.

5. An air induction system as set forth in claim 4 wherein one of said first member or said portion of said second component comprises a transparent material with said other of said first member or said portion of said second component being positioned internally relative to said transparent material to define said overlapping relationship.

6. An air induction system as set forth in claim 5 wherein said first member comprises a tube extending outwardly from said first component and said second component comprises a hose with one end of said hose engaging an external circumferential surface of one end of said tube to define said attachment interface.

7. An air induction system as set forth in claim 5 wherein said first member comprises a tube extending outwardly from said first component and said second component comprises a hose with one end of said hose engaging an internal circumferential surface of one end of said tube to define said attachment interface.

8. An air induction system as set forth in claim 5 wherein a laser beam is directed toward said transparent material to first heat said other of said first member or said portion of said second component with subsequent heating of said transparent material to generate said laser weld area.

9. An air induction system as set forth in claim 5 wherein said first member comprises a double tube extending outwardly from said first component and having an outer wall spaced apart from an inner wall to define a gap and said second component comprises a hose with one end of said hose being received within said gap to define said attachment interface.

10. An air induction system as set forth in claim 1 wherein said first component comprises a resonator and said second component comprises a hose.

11. An air induction system as set forth in claim 1 wherein said first component comprises an air cleaner and said second component comprises a hose.

12. An air induction system comprising:
an induction component made from a polyolefin material and defining an opening with a tube extending outwardly from said induction component around said opening;
a hose made from an elastomeric material with one hose end positioned relative to said tube in an overlapping relationship to define an attachment interface; and
a laser weld area formed at said attachment interface to securely attach said hose to said induction component.

13. An air induction system as set forth in claim 12 wherein one of said tube or hose end comprises a transparent material.

14. A method for attaching a first induction component to a second induction component in an air induction system comprising the steps of:
positioning the first and second induction components in an abutting relationship to define an overlap area; and
laser welding the overlap area to securely attach the first and second induction components together.

15. A method as set forth in claim 14 including the steps of forming the first induction component from a polyolefin material and the second induction component from an elastomeric material.

16. A method as set forth in claim 15 including the step of moving a laser beam relative to the first and second induction components to form a laser weld at the overlap area.

17. A method as set forth in claim 15 wherein the first induction component includes an extension and wherein the second induction component comprises a hose having a hose end and including the step of forming one of the extension or hose end from a transparent material.

18. A method as set forth in claim 17 wherein the extension comprises a tube extending outwardly from the first induction component and including the step of engaging an external circumferential surface of one end of the tube with an internal circumferential surface of the hose end to define the overlap area.

19. A method as set forth in claim 17 wherein the extension comprises a tube extending outwardly from the first induction component and including the step of engaging an internal circumferential surface of one end of the tube with an external circumferential surface of the hose end to define the overlap area.

20. A method as set forth in claim 17 wherein the extension comprises a double tube extending outwardly from the first induction component with an outer wall spaced apart from an inner wall to define a gap and including the step of inserting the hose end within the gap to define the overlap area.

21. A method as set forth in claim 17 including the steps of directing a laser beam through the transparent material to first heat the other of the extension or hose end with subsequent heating of the transparent material to generate a laser weld.
